(19) United States
(12) Patent Application Publication
(10) Pub. No.: US 2009/0180019 A1
(43) Pub. Date: Jul. 16, 2009

(54) HIGH MAGNIFICATION LENS MODULE AND DIGITAL IMAGING APPARATUS

(76) Inventor: Chih-Yi Yang, Taipei City (TW)

Correspondence Address: HDLS Patent & Trademark Services, P.O. BOX 220746, CHANTILLY, VA, 20153-0746, US

(21) Appl. No.: 12/013,457

(22) Filed: Jan. 13, 2008

(51) Int. Cl. G02B 13/16

(52) U.S. Cl. 348/335

(57) ABSTRACT

A high magnification lens module is coupled to a digital camera. The digital camera has an imaging lens. The high magnification lens module comprises an adapter ring, an optical magnifying unit connected to the adapter ring, and a focusing unit connected to the optical magnifying unit. The optical magnifying unit has a fiber optic taper. The fiber optic taper has a first facet facing the imaging lens and a second facet opposite to the first facet. The area of the first facet is larger than that of the second facet. The focusing unit has at least one lens facing the second facet.

### BACKGROUND OF THE INVENTION

1. Field of the Invention

The present invention relates to a lens, and in particular to a high magnification lens module that can be coupled to a digital camera.

2. Description of Prior Art

The digital camera is able to snap-and-watch, and the images generated thereby can be outputted to a computer or other associated apparatuses very easily. Because of the above advantages, the digital camera has already replaced the traditional camera that needs a film, and becomes a mainstream in the modern camera market.

However, the magnification of a common digital camera is in a range of several to tens factors. Thus, the digital camera can be only used to photograph common scenes, but not a microstructure on a surface of an object. On the other hand, the common optical microscopic apparatus such as a microscope is large in volume and thus it is not convenient to carry this microscope about. All the above restricts the application of the common microscope.

Taiwan Patent Publication No. M292708 owned by the inventor of the present application discloses an adapter for a microscope camera having high magnification, which can be mounted on a digital camera available in the market, thereby obtaining a high magnification imaging apparatus that has a simple structure and can be carried about easily.

Therefore, it is an important issue for those skilled in this art to simplify the structure of such a high magnification imaging apparatus, save the cost and expand the application thereof.

### SUMMARY OF THE INVENTION

The present invention is to provide a high magnification lens module that the structure thereof is simplified to save the cost, and thus the application thereof is expanded.

The present invention is to provide a digital imaging apparatus having the above-mentioned high magnification lens module.

The present invention provides a high magnification lens module coupled to a digital camera. The digital camera has a photo-sensitive element and an imaging lens for imaging an external object on the photo-sensitive element. The high magnification lens module comprises an adapter ring, an optical magnifying unit, and a focusing unit.

The adapter ring is coupled to the imaging lens of the digital camera. The optical magnifying unit has a first tube connected to the adapter ring and a fiber optic taper received in the first tube. The fiber optical fiber has a first facet facing the imaging lens and a second facet opposite to the first facet. The area of the first facet is larger than that of the second facet. The focusing unit is used to focus on the external object. The focusing unit has a second tube connected to the first tube, and at least one lens received in the second tube and facing the second facet of the fiber optic taper.

On the other hand, the present invention provides a digital imaging apparatus comprising a digital camera and a high magnification lens module.

The digital camera has a photo-sensitive element and an imaging lens for imaging an external object on the photo-sensitive element. The high magnification lens module comprises an adapter ring, an optical magnifying unit, and a focusing unit. The adapter ring is coupled to the imaging lens of the digital camera. The optical magnifying unit has a first tube connected to the adapter ring and a fiber optic taper received in the first tube. The fiber optical fiber has a first facet facing the imaging lens and a second facet opposite to the first facet. The area of the first facet is larger than that of the second facet. The focusing unit is used to focus on the external object. The focusing unit has a second tube connected to the first tube, and at least one lens received in the second tube and facing the second facet of the fiber optic taper.

The present invention provides an optical magnifying unit having a fiber optic taper, which has a simple structure and low cost, so that the application of the high magnification lens module can be expanded.

### BRIEF DESCRIPTION OF THE DRAWINGS

FIG. 1 is an exploded perspective view of the high magnification lens module of the present invention; and

FIG. 2 is an assembled cross-sectional view of the high magnification lens module of the present invention.

### DETAILED DESCRIPTION OF THE INVENTION

The detailed description and technical contents of the present invention will be explained with reference to the accompanying drawings. However, the drawings are illustrative only and are not used to limit the scope of the present invention.

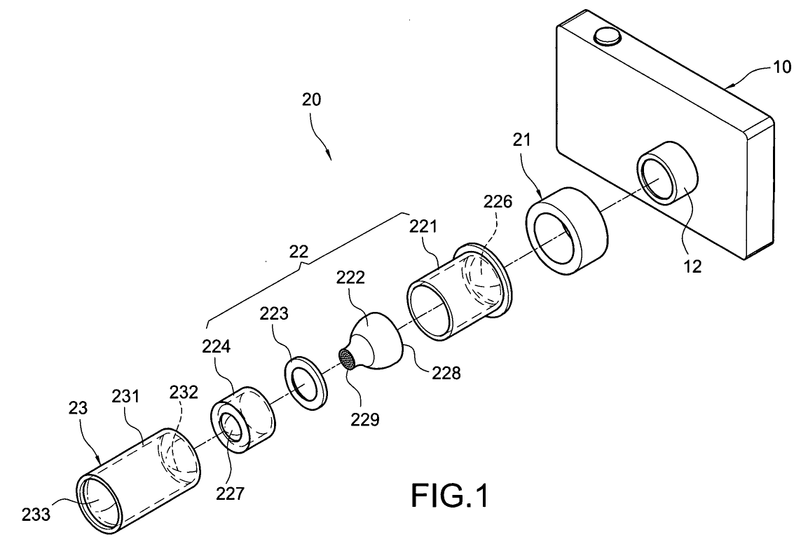

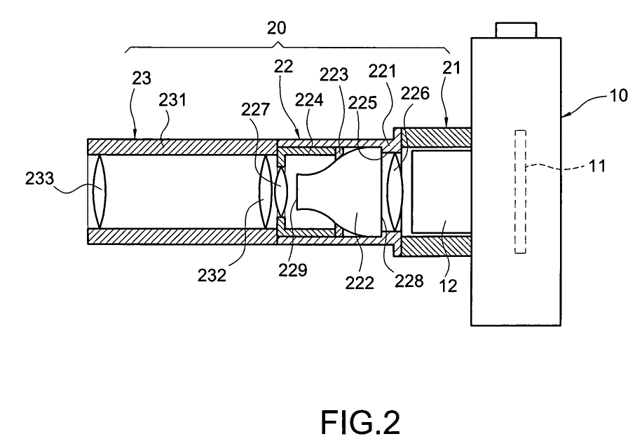

FIGS. 1 and 2 show a high magnification lens module 20 of a preferred embodiment of the present invention, which can be coupled to a digital camera 10. The digital camera 10 has a photo-sensitive element 11 and an imaging lens 12 for imaging an external object on the photo-sensitive element 11. The high magnification lens module 20 comprises an adapter ring 21, an optical magnifying unit 22 and a focusing unit 23.

The adapter ring 21 is coupled to the imaging lens 12 of the digital camera 10. The length of the adapter ring 21 is larger than that of the imaging lens 12.

The optical magnifying unit 22 has a first tube 221 connected to the adapter ring 21, a fiber optic taper 222 received in the first tube 221, and a ring 223 and a lining tube 224 that are fixed to an inner protrusion 225 of the first tube 221 via the fiber optic taper 222. The fiber optic taper 222 has a first facet 228 facing the imaging lens 12 and a second facet 229 opposite to the first facet 228.

The fiber optic taper 222 is made of a plurality of optical fibers by means of binding, partially heating, tensioning and cutting steps. The magnification of the fiber optic taper 222 is determined by the ratio of the area of the first facet 228 to the area of the second facet 229. In the present embodiment, the area of the first facet 228 is larger than that of the second facet 229, so that the fiber optic taper 222 has a positive magnification.

In addition, the optical magnifying unit 22 has a first lens 226 that is fixedly provided on the first tube 221 and located on the first facet 228 of the fiber optic taper 222, and a second lens 227 that is fixedly provided on the lining tube 224 and located on the second facet 229 of the fiber optic taper 222. The second lens 227 receives image light of an external object obtained by the focusing unit 23, and converts the image light into parallel light so as to be projected on the second facet 229 of the fiber optic taper 222. The first tube 226 receives the parallel light passing through the first facet 228 of the fiber optic taper 222, and images the external object on the photo-sensitive element 11 via the imaging lens 12.

The focusing unit 23 is used to focus on the external object. The focusing unit has a second tube 231 that is connected to the first tube 221, and two lenses 232, 233 that are received in the second tube 231. In practice, the focusing unit can be a microscope of a short focus, or a telescope of a long focus, and even an endoscope.

In the present embodiment, the high magnification lens module 20 of the present invention can be coupled to a digital camera 10 available in the market. Further, another embodiment of the present invention provides a high magnification imaging apparatus comprising the combination of the high magnification lens module 20 and the digital camera 10.

According to the above, the present invention provides an optical magnifying unit 20 comprising a fiber optic taper 222, which has a simple structure and low cost so as to expand the application of this high magnification lens module. Thus, the present invention really achieves the desired effects.

What is claimed is:

1. A high magnification lens module coupled to a digital camera, the digital camera having a photo-sensitive element and an imaging lens for imaging an external object on the photo-sensitive element, the high magnification lens module comprising:
an adapter ring coupled to the imaging lens;
an optical magnifying unit having a first tube connected to the adapter ring and a fiber optic taper received in the first tube, the fiber optic taper having a first facet facing the imaging lens and a second facet opposite to the first facet, the area of the first facet being larger than that of the second facet; and
a focusing unit for focusing on the external object, the focusing unit having a second tube connected to the first tube and at least one lens received in the second tube to face the second facet of the fiber optic taper.

2. The high magnification lens module according to claim 1, wherein the length of the adapter ring is larger than that of the imaging lens.

3. The high magnification lens module according to claim 1, wherein the fiber optic taper is made of a plurality of optical fibers by means of binding, partially heating, tensioning and cutting steps.

4. The high magnification lens module according to claim 1, wherein the optical magnifying unit has a second lens provided on the second facet of the fiber optic taper, the second lens receives image light of an external object obtained by the focusing unit and converts the image light into parallel light so as to be projected on the second facet.

5. The high magnification lens module according to claim 4, wherein the optical magnifying unit has a first lens provided on the first facet of the fiber optic taper, the first lens receives the parallel light passing through the first facet of the fiber optic taper and images the external object on the photo-sensitive element via the imaging lens.

6. The high magnification lens module according to claim 1, wherein the focusing unit is a microscope of a short focus, a telescope of a long focus, or an endoscope.

7. A digital imaging apparatus, comprising:
a digital camera, comprising:
a photo-sensitive element;
an imaging lens for imaging an external object on the photo-sensitive element;
a high magnification lens module, comprising:
an adapter ring coupled to the imaging lens of the digital camera;
an optical magnifying unit having a first tube connected to the adapter ring and a fiber optic taper received in the first tube, the fiber optic taper having a first facet facing the imaging lens and a second facet opposite to the first facet, the area of the first facet being larger than that of the second facet; and
a focusing unit for focusing on the external object, the focusing unit having a second tube connected to the first tube and at least one lens received in the second tube to face the second facet of the fiber optic taper.

8. The digital imaging apparatus according to claim 7, wherein the length of the adapter ring is larger than that of the imaging lens.

9. The digital imaging apparatus according to claim 7, wherein the fiber optic taper is made of a plurality of optical fibers by means of binding, partially heating, tensioning and cutting steps.

10. The digital imaging apparatus according to claim 7, wherein the optical magnifying unit has a second lens provided on the second facet of the fiber optic taper, the second lens receives image light of an external object obtained by the focusing unit and converts the image light into parallel light so as to be projected on the second facet.

11. The digital imaging apparatus according to claim 10, wherein the optical magnifying unit has a first lens provided on the first facet of the fiber optic taper, and the first lens receives the parallel light passing through the first facet of the fiber optic taper and images the external object on the photo-sensitive element via the imaging lens.

12. The digital imaging apparatus according to claim 7, wherein the focusing unit is a microscope of a short focus, a telescope of a long focus, or an endoscope.
